(19) United States
(12) Patent Application Publication
(10) Pub. No.: US 2021/0184982 A1
(43) Pub. Date: Jun. 17, 2021

(54) METHOD, DEVICE AND SYSTEM FOR CONTROLLING QUALITY OF SERVICE

(71) Applicant: ZTE CORPORATION, Guangdong (CN)

(72) Inventors: Zheng ZHANG, Guangdong (CN); Cui WANG, Guangdong (CN)

(21) Appl. No.: 16/079,637

(22) PCT Filed: Jul. 11, 2016
(86) PCT No.: PCT/CN2016/089655

§ 371 Date: Aug. 24, 2018

(30) Foreign Application Priority Data
Feb. 24, 2016 (CN) 201610101668.4

(51) Int. Cl. H04L 12/833; H04L 12/18; H04L 12/851

(52) U.S. Cl. CPC H04L 47/31; H04L 47/2408; H04L 12/1886

(57) ABSTRACT

A method for controlling quality of service, including steps of: transmitting, by a network device, a packet; and controlling the quality of service for the packet, by the network device, according to a Bit Indexed Explicit Replication (BIER)-information-based service quality strategy or according to a service quality related field carried by the packet. The method of the present disclosure can achieve controlling for quality of service based on BIER information, enhance flexibility of controlling for the quality of service in a network, and promote development of multicast technology and network.

### TECHNICAL FIELD

The present disclosure relates to, but is not limited to, the field of communication, and in particular, relates to a method, a device and a system for controlling quality of service.

### BACKGROUND

Multicast data communication is playing an increasingly important role in the Internet. For example, multicast technology is used for Interactive personality TV (IPTV), net-meeting, live broadcast, or the like. The existing multicast technology includes protocol independent multicast (PIM), internet group management protocol (IGMP), multicast listener discovery protocol (MLD) and so on, which can meet requirements of users in a small-scale application scene. However, as the multicast being used more and more widely and the network becoming more and more complex, when the multicast is directly used in the Internet, due to too many multicast states in the backbone network, a large number of control resources and signaling interactions of intermediate nodes are occupied, and the development of virtual private network (VPN) technology being used widely cannot be well supported. Thus, no multicast protocol running in the backbone network is preferred, and multicast traffic transmission is achieved by other technologies, such as Multicast Label Distribution Protocol (mLDP) technology, Point-to-Multipoint Traffic Engineering (P2MP TE) technology, Bit Indexed Explicit Replication (BIER) technology.

The core idea of BIER technology is that, only one bit (BIT) is used for indicating each node in the network, the multicast traffic is transmitted in the intermediate network with a particular BIER header packaged thereto, rather than in a form of a multicast Internet Protocol (IP) packet. The BIER header tags each destination node of the multicast traffic with BIT, and the intermediate network routes according to the BIT, which ensures that the multicast traffic can be transmitted to all destination nodes.

In a case where the multicast traffic transmission in the intermediate network is achieved by the mLDP technology, the P2MP TE technology, and the BIER technology, the P2MP TE technology can achieve a bandwidth guarantee of a particular multicast traffic by a traffic engineering (TE) mechanism. However, quality of service in a network using the BIER technology cannot be guaranteed by using an IP packet header, because there is no packet header of internet protocol version 4 (IPv4) or internet protocol version 6 (IPv6), which brings a great inconvenience to network control.

### SUMMARY

The present disclosure is summarized below, but the summary is not intended to limit the protection scope of the present disclosure.

Embodiments of the present disclosure provide a method, a device and a system for controlling quality of service, which can achieve controlling for quality of service based on BIER information, enhance the flexibility of controlling for quality of service in the network, and promote the development of multicast technology and network.

An embodiment of the present disclosure provides a method for controlling quality of service, including steps of: transmitting, by a network device, a packet; and controlling the quality of service for the packet, by the network device, according to a BIER-information-based service quality strategy or according to a service quality related field carried by the packet.

In some implementations, the method for controlling quality of service further includes: before controlling the quality of service for the packet, by the network device, according to the BIER-information-based service quality strategy or according to the service quality related field carried by the packet, acquiring, by the network device, the BIER-information-based service quality strategy from a controller device; or configuring, by the network device, the BIER-information-based service quality strategy.

In some implementations, the service quality related field carried by the packet is configured by the network device or the controller device.

In some implementations, the method for controlling quality of service further includes: configuring the service quality related field of the packet, by the network device, according to the BIER-information-based service quality strategy.

In some implementations, the service quality related field of the packet includes: a priority (EXP) field of a multi-protocol label switching (MPLS) label; or a type of service (TOS) field and a priority field of an internet protocol (IP) packet; or a type of service (TOS) field of an internet protocol (IP) packet; or a priority field of an internet protocol (IP) packet; or a TOS field of a BIER packet.

In some implementations, the BIER-information-based service quality strategy includes at least one of following BIER attribute information: type of BIER packet, version, sub-domain, bit-string-length, set identifier, entropy, bit-string, protocol field, and bit-forwarding ingress router identifier (BFIR-ID).

In some implementations, the step of controlling the quality of service for the packet includes: classifying the packet based on the quality of service and performing a corresponding process on the packet to control the quality of service for the packet.

An embodiment of the present disclosure further provides a device for controlling quality of service, which is applied in a network device, including: a transmitter, configured to transmit a packet; and a processor component, configured to control the quality of service for the packet according to a BIER-information-based service quality strategy or according to a service quality related field carried by the packet.

In some implementations, the device for controlling quality of service further includes: an acquiring component, configured to acquire the BIER-information-based service quality strategy from a controller device; or a first configuration component, configured to configure the BIER-information-based service quality strategy.

In some implementations, the service quality related field carried by the packet is configured by the network device or the controller device.

In some implementations, the device for controlling quality of service further includes: a second configuration component, configured to configure the service quality related field of the packet according to the BIER-information-based service quality strategy.

In some implementations, the service quality related field of the packet includes: an EXP field of a MPLS label; or a TOS field and a priority field of an IP packet; or a TOS field of an IP packet; or a priority field of an IP packet; or a TOS field of a BIER packet.

In some implementations, the BIER-information-based service quality strategy includes at least one of following BIER attribute information: type of BIER packet, version, sub-domain, bit-string-length, set identifier, entropy, bit-string, protocol field, and bit-forwarding ingress router identifier (BFIR-ID).

In some implementations, the processor component is configured to classify the packet based on the quality of service and perform a corresponding process on the packet to control the quality of service for the packet according to the BIER-information-based service quality strategy or according to the service quality related field carried by the packet.

An embodiment of the present disclosure further provides a system for controlling quality of service, including a network device and a controller device, the controller device is configured to configure a BIER-information-based service quality strategy, and/or configure a service quality related field of a packet according to the BIER-information-based service quality strategy, and the network device is correspondingly configured to control the quality of service for the packet according to the BIER-information-based service quality strategy or according to the service quality related field carried by the packet.

An embodiment of the present disclosure further provides a computer readable storage medium which storages a computer executable instruction, the computer executable instruction is executed to achieve the method for controlling quality of service described above.

In embodiments of the present disclosure, the network device transmits the packet, and controls the quality of service for the packet according to the BIER-information-based service quality strategy or according to the service quality related field carried by the packet. With the embodiments of the present disclosure, controlling for quality of service based on BIER information is achieved, avoiding a defect that BIER network cannot control quality of traffic service flexibly, improving the reliability of controlling for quality of network service, and promoting the development of multicast technology and network well.

Other aspects will be apparent by reading and understanding the accompany drawings and detailed descriptions.

### BRIEF DESCRIPTION OF DRAWINGS

FIG. 1 shows a flowchart of a method for controlling quality of service in an embodiment of the present disclosure;

FIG. 2 shows a flowchart of a method for controlling quality of service in an embodiment of the present disclosure;

FIG. 3 shows a flowchart of a method for controlling quality of service in an embodiment of the present disclosure;

FIG. 4 shows a diagram of an application scene of an embodiment of the present disclosure;

FIG. 5 shows a diagram of implementation of a method for controlling quality of service according to an embodiment of the present disclosure in the application scene shown in FIG. 4;

FIG. 6 shows a diagram of another application scene of an embodiment of the present disclosure;

FIG. 7 shows a diagram of implementation of a method for controlling quality of service according to an embodiment of the present disclosure in the application scene shown in FIG. 6;

FIG. 8 shows a diagram of implementation of a method for controlling quality of service according to an embodiment of the present disclosure in further another application scene;

FIG. 9 shows a diagram of implementation of a method for controlling quality of service according to an embodiment of the present disclosure in still another application scene;

FIG. 10 shows a diagram of a device for controlling quality of service in an embodiment of the present disclosure;

FIG. 11 shows another diagram of a device for controlling quality of service in an embodiment of the present disclosure;

FIG. 12 shows a diagram of a system for controlling quality of service in an embodiment of the present disclosure.

### DETAILED DESCRIPTION

Embodiments of the present disclosure are illustrated in detail below in conjunction with the accompanying drawings. It should be understood that, the embodiments illustrated below are only used for illustrating and explaining technical solutions of the present disclosure and are not intended to limit the protection scope of the present disclosure.

Steps shown by the flowcharts in the drawings may be implemented as a set of computer executable instructions that a computer system can execute. Although the flowchart shows a logic order, in some cases, the steps illustrated or described may be performed in an order different from that shown in the flowcharts.

FIG. 1 shows a flowchart of a method for controlling quality of service in an embodiment of the present disclosure. As shown in FIG. 1, the method for controlling quality of service includes steps of: transmitting, by a network device, a packet (step 101); and controlling the quality of service for the packet, by the network device, according to a BIER-information-based service quality strategy or according to a service quality related field carried by the packet (step 102).

In some implementations, the method for controlling quality of service further includes: before step 102, acquiring, by the network device, the BIER-information-based service quality strategy from a controller device; or configuring, by the network device, the BIER-information-based service quality strategy.

With such implementations, the network device can directly configure the BIER-information-based service quality strategy, or the network device can acquire the BIER-information-based service quality strategy from the controller device and the controller device can directly configure the BIER-information-based service quality strategy.

In some implementations, the service quality related field carried by the packet is configured by the network device or the controller device.

That is to say, the service quality related field of the packet may be configured by the network device itself, or may be configured by the controller device.

In some implementations, the method for controlling quality of service further includes: configuring the service quality related field of the packet, by the network device, according to the BIER-information-based service quality strategy.

In some implementations, the service quality related field of the packet includes: a priority (EXP) field of a multi-protocol label switching (MPLS) label; or a type of service (TOS) field and a priority field of an internet protocol (IP) packet; or a type of service (TOS) field of an internet protocol (IP) packet; or a priority field of an internet protocol (IP) packet; or a TOS field of a BIER packet.

In some implementations, the BIER-information-based service quality strategy includes at least one of following BIER attribute information: type of BIER packet, version, sub-domain, bit-string-length, set identifier, entropy, bit-string, protocol field, bit-forwarding ingress router identifier (BFIR-ID).

In some implementations, the step of controlling the quality of service for the packet includes: classifying the packet based on the quality of service and performing a corresponding process on the packet to control the quality of service for the packet.

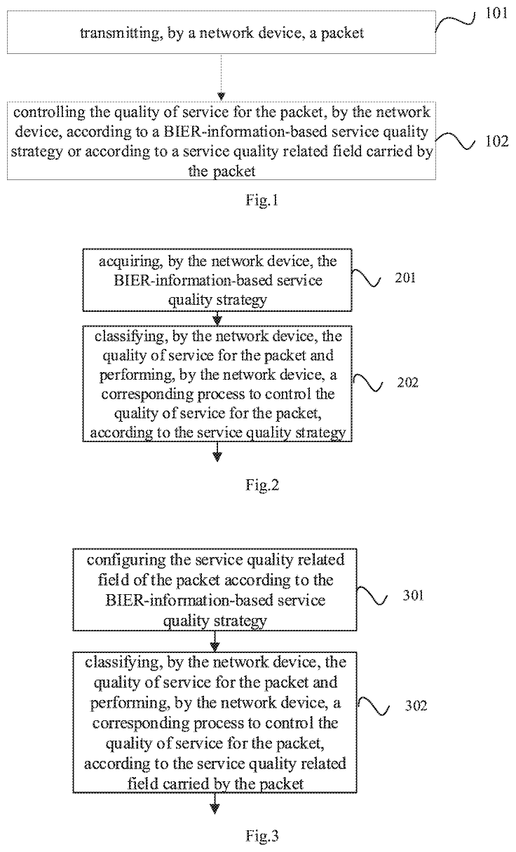

FIG. 2 shows a flowchart of a method for controlling quality of service in an embodiment of the present disclosure. In the present embodiment, the network device controls the quality of service according to the BIER-information-based service quality strategy.

As shown in FIG. 2, the method for controlling quality of service includes following steps 201 and 202.

At step 201, the network device acquires the BIER-information-based service quality strategy.

The service quality strategy may be directly configured by the network device, or obtained from the controller device, and the controller device can directly configure the BIER-information-based service quality strategy.

In some implementations, the service quality strategy includes at least one of following BIER attributes: type of BIER packet, version, sub-domain, bit-string-length, set identifier, entropy, bit-string, protocol field, and BFIR-ID. The BIER attributes may be combined arbitrarily according to actual conditions to obtain the service quality strategy.

At step 202, the network device classifies the packet based on the quality of service, and performs a corresponding process on the packet to control the quality of service for the packet, according to the service quality strategy. For example, the priority or a queue, etc. is configured for the packet, and bandwidth guarantee, speed limiting, traffic scheduling or the like is performed.

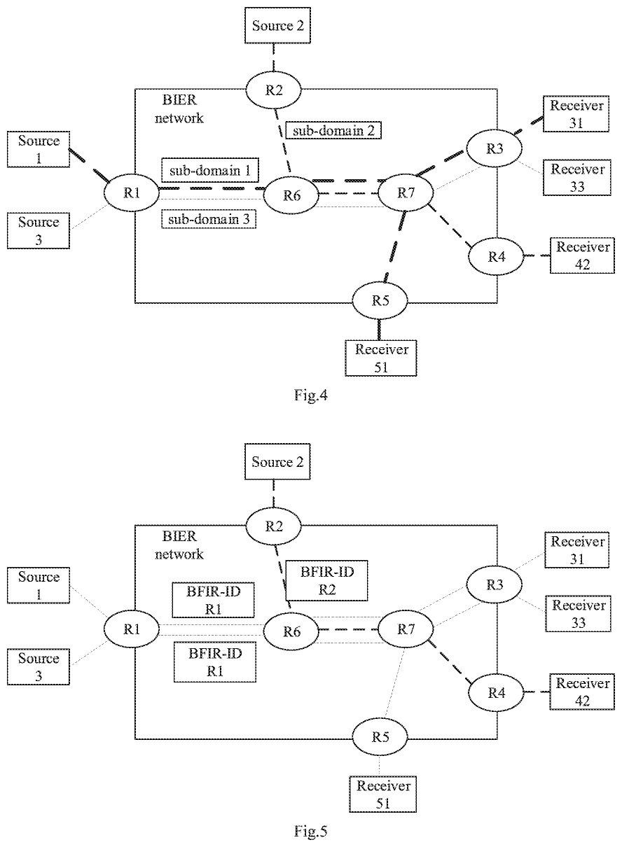

FIG. 3 shows a flowchart of a method for controlling quality of service in an embodiment of the present disclosure. In the present disclosure, the network device controls the quality of service according to the service quality related field carried by the packet.

As shown in FIG. 3, the method for controlling quality of service includes following steps 301 and 302.

At step 301, the service quality related field of the packet is configured according to the BIER-information-based service quality strategy.

The step 301 may be performed by the network device itself, or by the controller device or other related management device.

In some implementations, the service quality strategy includes at least one of following BIER attributes: type of BIER packet, version, sub-domain, bit-string-length, set identifier, entropy, bit-string, protocol field, and BFIR-ID. The BIER attributes may be combined arbitrarily according to actual conditions to obtain the service quality strategy.

In some implementations, the service quality related field of the packet configured at this step may be an EXP field of a MPLS label, or may be a TOS field and a priority field of an IP packet, or may be a TOS field of an IP packet, or may be a priority field of an IP packet, or may be a TOS field of a BIER packet.

At step 302, the network device classifies the packet based on the quality of service, and performs a corresponding process on the packet to control the quality of service for the packet, according to the service quality related field carried by the packet. For example, the priority or a queue, etc. is configured for the packet, and bandwidth guarantee, speed limiting, traffic scheduling or the like is performed.

As an example, in a hybrid network, the quality of service is controlled for different packets, and the service quality strategy may be defined as follows: If (packet is BIER) THEN (guarantee 50% of available BW); If (packet is IP) THEN (guarantee 40% of available BW); If (packet is MPLS) THEN (guarantee 10% of available BW).

That is to say, the route of data traffic carried by BIER packet can be guaranteed by 50% of the bandwidth, the route of data traffic carried by IP packet can be guaranteed by 40% of the bandwidth, and the route of data traffic carried by MPLS packet is guaranteed by a minimum cost, i.e., 10% of the bandwidth. According to the service quality strategy described above, the network device provides a service quality guarantee for corresponding route of data traffic.

Solutions in accordance with the embodiments of the present disclosure will be illustrated in detail below in conjunction with specific application scenes.

FIG. 4 shows a diagram of an application scene of an embodiment of the present disclosure, and FIG. 5 shows a diagram of implementation of a method for controlling quality of service according to an embodiment of the present disclosure in the application scene as shown in FIG. 4.

As shown in FIG. 4, supposing that there are three routes of traffics, the three routes of traffics may enter into the BIER network through the network devices R1 and R2 respectively, and then, they may be forwarded by the network devices R6 and R7 to arrive at edge nodes R3, R4 and R5 of the BIER network. As required by network management, the route of traffic that belongs to a first sub-domain is a route of data traffic that needs to be guaranteed firstly, the route of traffic that belongs to a second sub-domain is a route of data traffic that needs to be guaranteed secondarily, and the route of traffic that belongs to a third sub-domain is a most common route of data traffic. In the related BIER network, all related network devices R1 through R7 in the BIER network cannot control the quality of service according to the sub-domain, but can only act fairly to all the sub-domains. Thus, the route of data traffic that needs to be guaranteed firstly cannot be really guaranteed, resulting in a significant impact on the quality of service of the BIER network, and being not able to achieve a traffic-distinguished controlling for quality of service. Similarly, other fields carried by the packet of the BIER network, such as bit-string-length, set identifier, entropy, bit-string, BFIR-ID, version, protocol field, cannot be recognized according to the related technology either, being not able to guarantee the quality of service according to these fields.

In this regard, supposing that, in the BIER network as shown in FIG. 4, the quality of service of the route of data traffic is to be determined according to an entrance device of the BIER network through which the route of traffic enters into the BIER network. As required by network management, the route of traffic from the network device R2 needs to be guaranteed firstly, and as shown in FIG. 5, each network device of the BIER network can directly configure the service quality strategy. For example, the route of traffic from the network device with BFIR-ID of R2 needs to be guaranteed by 50% of the bandwidth or has a highest priority. Other network devices of the BIER network, such as network devices with BFIR-IDs of R3, R4, R6 and R7, may guarantee the quality of service according to such service quality strategy.

In some implementations, in a case where the route of traffic enters into the BIER network through the network device R2, the network device R2 may configure the service quality related field of the BIER packet according to the service quality strategy, or configures an EXP field of a MPLS packet of BIER. Other network devices of the BIER network, such as network devices with BFIR-IDs of R3, R4, R6 and R7 directly guarantee the corresponding quality of service according to the service quality related field of the BIER packet or the EXP field of the MPLS packet of BIER.

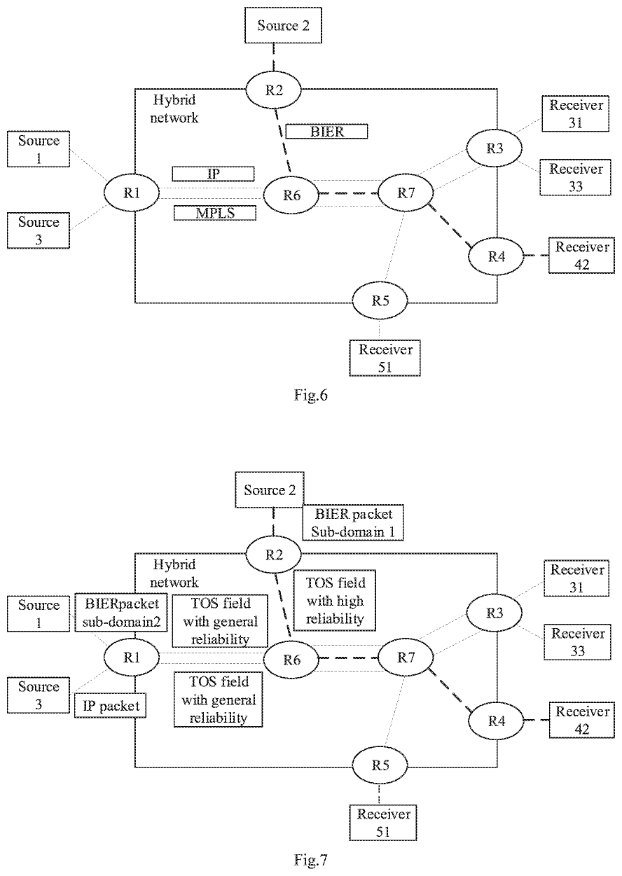

FIG. 6 shows a diagram of another application scene of an embodiment of the present disclosure, and FIG. 7 shows a diagram of implementation of a method for controlling quality of service according to an embodiment of the present disclosure in the application scene as shown in FIG. 6.

As shown in FIG. 6, supposing that there are three routes of traffics, the three routes of traffics may enter into a hybrid network through the network devices R1 and R2 respectively, and then, they may be forwarded by the network devices R6 and R7 to arrive at edge nodes R3, R4 and R5 of the BIER network. Packets that may enter into the hybrid network include IP packets, MPLS packets and BIER packets. As required by network management, the route of traffic of BIER packets needs to be guaranteed firstly. However, the related network devices can only recognize IP packets and MPLS packets, resulting in that the route of traffic of BIER packets cannot be guaranteed firstly.

As shown in FIG. 7, supposing that, as required by network management, the quality of service for the route of traffic of BIER packets from the first sub-domain needs to be guaranteed at a high priority. In this case, when the route of traffic enters into the network, the service quality related field of the packet, such as TOS field and priority filed of IP packet, TOS field of IP packet, priority filed of IP packet, EXP field of MPLS packet, or TOS field of BIER packet, is configured according to the BIER-information-based service quality strategy, and each network device in the network directly guarantee the corresponding quality of service according to the service quality related field of the packet.

In some implementations, each network device of the network can directly configure the service quality strategy, for example, the route of traffic of BIER packets from the first sub-domain needs to be guaranteed at a high priority. Each network device in the network guarantees the quality of service according to such strategy.

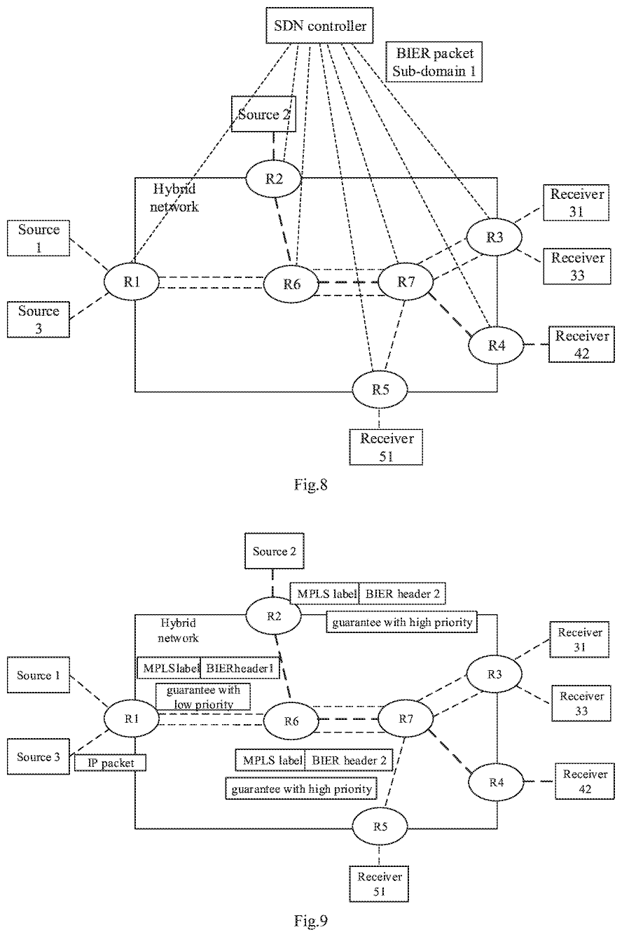

FIG. 8 shows a diagram of implementation of a method for controlling quality of service according to an embodiment of the present disclosure in further another application scene. In such application scene, the BIER-information-based service quality strategy is issued to the network devices of the network by a controller device in a unified way.

In some implementations, the service quality strategy includes at least one of following BIER attributes: type of BIER packet, version, sub-domain, bit-string-length, set identifier, entropy, bit-string, protocol field, BFIR-ID and so on. The BIER attributes may be combined arbitrarily according to actual conditions to obtain the service quality strategy.

In this regard, the controller device may be a software defined network (SDN) controller. However, the present disclosure is not limited thereto. The controller device may also be any other entity or virtual management device.

In this regard, the controller device may issue the service quality strategy to all devices of the network.

In some implementations, the controller device may issue the service quality strategy to the entrance devices of the network through which the route of traffic enters into the network, and the entrance devices configure the service quality related field of the corresponding packet.

FIG. 9 shows a diagram of implementation of a method for controlling quality of service according to an embodiment of the present disclosure in still another application scene. As shown in FIG. 9, supposing that the traffic in the network is transmitted in a form of MPLS packets of BIER, the network device also can guarantee the quality of service based on the BIER header information carried by the MPLS packets of BIER. The BIER header information includes at least one of following BIER attributes: version, bit-string-length, set identifier, entropy, bit-string, protocol field, BFIR-ID, existing TOS/EXP information and so on. The BIER attributes may be combined arbitrarily according to actual conditions to obtain the service quality strategy.

In some implementations, the BIER header is packaged by the MPLS label, and the network device can find corresponding BIER forwarding items through the label, wherein the items includes information of a sub-domain, a set identifier, and a bit-string-length, which corresponds to the label. At least one of attributes in such information, or in combination with the BIER header information, forms the service quality strategy.

In some implementations, the BIER-information-based service quality strategy may be issued to each network device, or issued to only entrance devices through which the traffic enters into the network, by the controller device. Then, each network device or the entrance devices may correspondingly guarantee the quality of service.

The embodiments of the present disclosure may be implemented separately or in any combination thereof.

With the embodiments of the present disclosure, it is easy to guarantee the quality of service based on the BIER information. A network using the BIER technology can define the service quality strategy according to actual conditions flexibly, significantly improving the controllability of the BIER network, enhancing the reliability of the network, and promoting the development of the network well.

An embodiment of the present disclosure further provides a device for controlling quality of service, which is applied in a network device, including: a transmitter, configured to transmit a packet; and a processor component, configured to control the quality of service for the packet according to a BIER-information-based service quality strategy or according to a service quality related field carried by the packet.

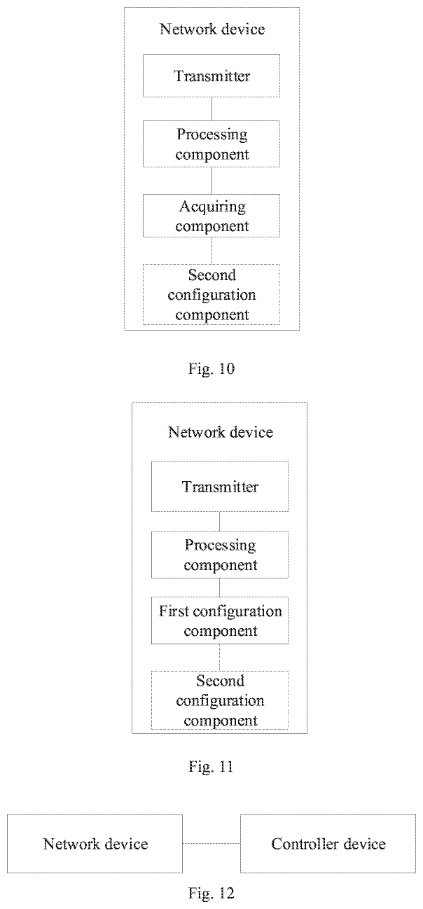

In some implementations, as shown in FIG. 10, the device for controlling quality of service further includes: an acquiring component, configured to acquire the BIER-information-based service quality strategy from a controller device.

In some implementations, as shown in FIG. 10, the device for controlling quality of service further includes: a second configuration component, configured to configure the service quality related field of the packet according to the BIER-information-based service quality strategy.

In some implementations, the service quality related field carried by the packet is configured by the network device or the controller device.

In some implementations, the service quality related field of the packet includes: an EXP field of a MPLS label; or a TOS field and a priority field of an IP packet; or a TOS field of an IP packet; or a priority field of an IP packet; or a TOS field of a BIER packet.

In some implementations, the BIER-information-based service quality strategy includes at least one of following BIER attribute information: type of BIER packet, version, sub-domain, bit-string-length, set identifier, entropy, bit-string, protocol field, and BFIR-ID.

In some implementations, as shown in FIG. 11, the device for controlling quality of service further includes: a first configuration component, configured to configure the BIER-information-based service quality strategy.

In some implementations, as shown in FIG. 11, the device for controlling quality of service further includes: a second configuration component, configured to configure the service quality related field of the packet according to the BIER-information-based service quality strategy.

In some implementations, the service quality related field carried by the packet is configured by the network device or the controller device.

In some implementations, the service quality related field of the packet includes: an EXP field of a MPLS label; or a TOS field and a priority field of an IP packet; or a TOS field of an IP packet; or a priority field of an IP packet; or a TOS field of a BIER packet.

In some implementations, the BIER-information-based service quality strategy includes at least one of following BIER attribute information: type of BIER packet, version, sub-domain, bit-string-length, set identifier, entropy, bit-string, protocol field, and BFIR-ID.

In some implementations, the processor component is configured to classify the packet based on the quality of service and perform a corresponding process on the packet to control the quality of service for the packet according to the BIER-information-based service quality strategy or according to the service quality related field carried by the packet.

In practical applications, the transmitter and the acquiring component may be implemented by a wired communication device, and the processor component, the first configuration component and the second configuration component may be implemented by a processor, but the present disclosure is not limited thereto.

FIG. 12 shows a diagram of a system for controlling quality of service in an embodiment of the present disclosure. As shown in FIG. 12, the system for controlling quality of service includes a network device and a controller device, the controller device is configured to configure a BIER-information-based service quality strategy, and/or configure a service quality related field of a packet according to the BIER-information-based service quality strategy, and the network device is correspondingly configured to control the quality of service for the packet according to the BIER-information-based service quality strategy or according to the service quality related field carried by the packet.

In the embodiment, in a case where the controller device is configured to configure the BIER-information-based service quality strategy, the network device may be configured to control the quality of service for the packet according to the BIER-information-based service quality strategy acquired from the controller device. Or, in a case where the controller device is configured to configure the BIER-information-based service quality strategy, the network device may be configured to configure the service quality related field of the packet according to the BIER-information-based service quality strategy acquired from the controller device, and control the quality of service for the packet according to the service quality related field of the packet. Or, in a case where the controller device is configured to configure the service quality related field of the packet according to the configured BIER-information-based service quality strategy, the network device may be configured to control the quality of service for the packet according to the service quality related field carried by the packet.

The processing procedure of the device and system for controlling quality of service is the same as that in the method for controlling quality of service described above, thus will not be described repeatedly.

An embodiment of the present disclosure further provides a computer readable storage medium which storages a computer executable instruction, the computer executable instruction is executed to achieve the method for controlling quality of service described above.

By referring to description of the embodiments of the present disclosure, it is clear for persons skilled in the art that the method of the embodiments of the present disclosure may be implemented by software in combination with a general hardware platform, or by hardware. That is, the technical solution of the present disclosure which makes a contribution to the related technology may be provided by a software product, the software product is stored in a storage medium (e.g., a ROM/RAM, a magnetic disc and a compact disc) and includes instructions which are executed by a terminal device (e.g., mobile phone, computer, server, or network device) to achieve the method of the embodiments of the present disclosure.

It is obvious for persons skilled in the art that components or steps of the present disclosure may be implemented by a general computing device, and in this case, they may be integrated in a single computing device or distributed over a network composed of a plurality of computing devices, additionally, they may be implemented by a program which is to be executed by the computing device, wherein the program may be storage in a storage device to be executed by the computing device. In some cases, the steps of the present disclosure may be performed in an order different from that shown in the present disclosure. The components or the steps of the present disclosure may be implemented by separate integrated circuits respectively, or more than one of them may be implemented by a single integrated circuit. The present disclosure is not limited to any particular combination of hardware and software.

The embodiments of the present disclosure described above are merely exemplary embodiments, and the present disclosure is not limited thereto. Various modifications and substitutions without departing from the conception of the present disclosure are obvious for persons skilled in the art, and any of these modifications and substitutions should be considered as falling into the protection scope of the present disclosure.

### INDUSTRIAL APPLICABILITY

The embodiments of the present disclosure provide a method, a device and a system for controlling quality of service, which can achieve controlling for quality of service based on BIER information, avoiding a defect that BIER network cannot control the quality of traffic service flexibly, improving the reliability of controlling for the quality of network service, and promoting the development of multicast technology and network well.

1. A method for controlling quality of service, comprising steps of:
transmitting, by a network device, a packet; and
controlling the quality of service for the packet, by the network device, according to a Bit Indexed Explicit Replication (BIER)-information-based service quality strategy or according to a service quality related field carried by the packet.

2. The method of claim 1, wherein in a case of controlling the quality of service for the packet, by the network device, according to a Bit Indexed Explicit Replication (BIER)-information-based service quality strategy, the method further comprising:
before the step of controlling the quality of service for the packet, by the network device, according to the BIER-information-based service quality strategy or according to the service quality related field carried by the packet, acquiring, by the network device, the BIER-information-based service quality strategy from a controller device; or
configuring, by the network device, the BIER-information-based service quality strategy.

3. The method of claim 1, wherein in a case of controlling the quality of service for the packet, by the network device, according to a service quality related field carried by the packet, the service quality related field carried by the packet is configured by the network device or the controller device.

4. The method of claim 1, further comprising:
configuring the service quality related field carried by the packet, by the network device, according to the BIER-information-based service quality strategy.

5. The method of claim 1, wherein the service quality related field carried by the packet comprises:
a priority (EXP) field of a multi-protocol label switching (MPLS) label; or
a type of service (TOS) field and a priority field of an Internet Protocol (IP) packet; or
a type of service (TOS) field of an Internet Protocol (IP) packet; or
a priority field of an Internet Protocol (IP) packet; or
a TOS field of a BIER packet.

6. The method of claim 1, wherein the BIER-information-based service quality strategy comprises at least one of following BIER attribute information: type of BIER packet, version, sub-domain, bit-string-length, set identifier, entropy, bit-string, protocol field, and bit-forwarding ingress router identifier (BFIR-ID).

7. The method of claim 1, wherein the step of controlling the quality of service for the packet comprises:
classifying the packet based on the quality of service and performing a corresponding process on the packet to control the quality of service for the packet.

8. A device for controlling quality of service, which is applied in a network device, comprising:
a transmitter, configured to transmit a packet; and
a processor component, configured to control the quality of service for the packet according to a Bit Indexed Explicit Replication (BIER)-information-based service quality strategy or according to a service quality related field carried by the packet.

9. The device of claim 8, further comprising:
an acquiring component, configured to acquire the BIER-information-based service quality strategy from a controller device; or
a first configuration component, configured to configure the BIER-information-based service quality strategy.

10. The device of claim 8, wherein the service quality related field carried by the packet is configured by the network device or the controller device.

11. The device of claim 8, further comprising:
a second configuration component, configured to configure the service quality related field of the packet according to the BIER-information-based service quality strategy.

12. The device of claim 8, wherein the service quality related field of the packet comprises:
an priority (EXP) field of a multi-protocol label switching (MPLS) label; or
a type of service (TOS) field and a priority field of an Internet Protocol (IP) packet; or
a type of service (TOS) field of an Internet Protocol (IP) packet; or
a priority field of an Internet Protocol (IP) packet; or
a TOS field of a BIER packet.

13. The device of claim 8, wherein the BIER-information-based service quality strategy comprises at least one of following BIER attribute information: type of BIER packet, version, sub-domain, bit-string-length, set identifier, entropy, bit-string, protocol field, and bit-forwarding ingress router identifier (BFIR-ID).

14. The device of claim 8, wherein the processor component is configured to classify the packet based on the quality of service and perform a corresponding process on the packet to control the quality of service for the packet according to the BIER-information-based service quality strategy or according to the service quality related field carried by the packet.

15. A system for controlling quality of service, comprising a network device and a controller device,
the controller device is configured to configure a BIER-information-based service quality strategy, and/or configure a service quality related field of a packet according to the BIER-information-based service quality strategy, and
the network device is correspondingly configured to control the quality of service for the packet according to the BIER-information-based service quality strategy or according to the service quality related field carried by the packet.

16. The method of claim 3, wherein the service quality related field of the packet comprises:
a priority (EXP) field of a multi-protocol label switching (MPLS) label; or
a type of service (TOS) field and a priority field of an Internet Protocol (IP) packet; or
a type of service (TOS) field of an Internet Protocol (IP) packet; or
a priority field of an Internet Protocol (IP) packet; or
a TOS field of a BIER packet.

17. The method of claim 4, wherein the service quality related field of the packet comprises:
a priority (EXP) field of a multi-protocol label switching (MPLS) label; or
a type of service (TOS) field and a priority field of an Internet Protocol (IP) packet; or
a type of service (TOS) field of an Internet Protocol (IP) packet; or
a priority field of an Internet Protocol (IP) packet; or
a TOS field of a BIER packet.

18. The method of claim 2, wherein the BIER-information-based service quality strategy comprises at least one of following BIER attribute information: type of BIER packet, version, sub-domain, bit-string-length, set identifier, entropy, bit-string, protocol field, and bit-forwarding ingress router identifier (BFIR-ID).

19. The method of claim 4, wherein the BIER-information-based service quality strategy comprises at least one of following BIER attribute information: type of BIER packet, version, sub-domain, bit-string-length, set identifier, entropy, bit-string, protocol field, and bit-forwarding ingress router identifier (BFIR-ID).
